(19) United States
(12) Patent Application Publication
(10) Pub. No.: US 2024/0112077 A1
(43) Pub. Date: Apr. 4, 2024

(54) PERFORMING PROACTIVE DRIVING TRAINING USING AN AUTONOMOUS VEHICLE

(71) Applicant: International Business Machines Corporation, Armonk, NY (US)

(72) Inventors: Tushar Agrawal, West Fargo, ND (US); Martin G. Keen, Cary, NC (US); Jeremy R. Fox, Georgetown, TX (US); Sarbajit K. Rakshit, Kolkata (IN)

(21) Appl. No.: 17/958,624

(22) Filed: Oct. 3, 2022

(51) Int. Cl. G06N 20/00; B60W 60/00

(52) U.S. Cl. CPC G06N 20/00; B60W 60/0015; B60W 60/005; B60K 35/00

(57) ABSTRACT

Embodiments of the present invention provide an approach for providing in-vehicle predicted context-based proactive driving training using an autonomous vehicle. A knowledge corpus is established from a driver's previous driving experience. A potential driving context (or scenario) is identified for a forthcoming driving route. An experience gap analysis is performed between the driver's experience and the potential driving context. If an experience gap exists, an in-vehicle mixed reality driving training simulation is provided in a selected location by the autonomous vehicle. The driver's responses to the training simulation can optionally be monitored and a determination can made based on the driver responses as to the suitability of the driver to safely address the potential driving context.

### TECHNICAL FIELD

The present invention relates to vehicle driving training, and more specifically to embodiments for providing in-vehicle predicted context-based proactive driving training using an autonomous vehicle.

### BACKGROUND

An autonomous vehicle, or a driverless vehicle, is generally defined as one that can operate itself and perform at least some necessary functions without any human intervention, through its ability to sense its surroundings. An autonomous vehicle most often utilizes a fully automated driving system to allow the vehicle to respond to external conditions that a human driver otherwise would manage. There are typically six different levels of automation and, as the levels increase, the extent of the driverless car's independence regarding operation control increases.

### SUMMARY

Embodiments of the present invention provide an approach for providing in-vehicle predicted context-based proactive driving training using an autonomous vehicle. A knowledge corpus is established from a driver's previous driving experience. A potential driving context (or scenario) is identified for a forthcoming driving route. An experience gap analysis is performed between the driver's experience and the potential driving context. If an experience gap exists, mixed reality driving training simulation is provided in a selected location. The driver's responses to the training simulation are monitored and a determination is made based on the driver responses as to the suitability of the driver to safely address the potential driving context.

A first aspect of the present invention provides a method for in-vehicle predicted context-based proactive driving training comprising: predicting, by a processor of a computing system, a driving context of a forthcoming driving route; performing an experience gap analysis between a driving experience of the driver and the predicted driving context to identify an experience gap; providing by an autonomous vehicle, in response to the experience gap being identified, an in-vehicle driving training simulation to the driver related to the predicted driving context; evaluating a driver's response to the driving training simulation to produce a driving performance score; and determining, based on the driving performance score, a suitability of the driver to safely navigate the predicted forthcoming driving route.

A second aspect of the present invention provides a computing system for an autonomous vehicle, comprising: a processor; a memory device coupled to the processor; and a computer readable storage device coupled to the processor, wherein the storage device contains program code executable by the processor via the memory device to implement a method for predicted context-based proactive driving training for a driver of the autonomous vehicle when in a manual driving mode, the method comprising: predicting, by a processor of a computing system, a driving context of a forthcoming driving route; performing an experience gap analysis between a driving experience of the driver and the predicted driving context to identify an experience gap; providing by an autonomous vehicle, in response to the experience gap being identified, an in-vehicle driving training simulation to the driver related to the predicted driving context; evaluating a driver's response to the driving training simulation to produce a driving performance score; and determining, based on the driving performance score, a suitability of the driver to safely navigate the predicted forthcoming driving route.

A third aspect of the present invention provides a computer program product for in-vehicle predicted context-based proactive driving training, the computer program product comprising a computer readable storage device, and program instructions stored on the computer readable storage device, to: predict a driving context of a forthcoming driving route; perform an experience gap analysis between a driving experience of the driver and the predicted driving context to identify an experience gap; provide by an autonomous vehicle, in response to the experience gap being identified, an in-vehicle driving training simulation to the driver related to the predicted driving context; evaluate a driver's response to the driving training simulation to produce a driving performance score; and determine, based on the driving performance score, a suitability of the driver to safely navigate the predicted forthcoming driving route.

### BRIEF DESCRIPTION OF THE DRAWINGS

FIG. 1 depicts a block diagram illustrating a driving training simulation system architecture for providing in-vehicle predicted context-based proactive driving training using an autonomous vehicle in accordance with embodiments of the present invention.

FIG. 2 depicts a flow chart of a method for in-vehicle predicted context-based proactive driving training using an autonomous vehicle, in accordance with embodiments of the present invention.

FIG. 3 depicts an example of in-vehicle predicted context-based proactive driving training using an autonomous vehicle, in accordance with embodiments of the present invention.

FIG. 4 depicts a block diagram of a computer system for the driving training simulation system of FIG. 1, capable of implementing in-vehicle predicted context-based proactive driving training using an autonomous vehicle, in accordance with embodiments of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

An autonomous vehicle is a vehicle that can sense its environment and navigate the environment with little or no user input. Autonomous vehicles use sensing devices, such as radar, lidar, image sensors, and/or the like, to do so. The autonomous vehicle system can further use information from Global Positioning System (GPS) technology, navigation systems, vehicle-to-vehicle communications, vehicle-to-infrastructure technology, and/or drive-by-wire systems to navigate the vehicle.

Levels of automation can be divided into six different levels such that, as the levels increase, the extent of the driverless car's independence regarding operation control increases. At level 0, the car has no control over its operation and the human driver does all driving. At level 1, the vehicle's ADAS (advanced driver assistance system) can support the driver with either steering or accelerating and braking. At level 2, the ADAS can oversee steering and accelerating and braking in some conditions, although the human driver is required to continue paying complete attention to the driving environment throughout the journey, while also performing the remainder of the necessary tasks. At level 3, the ADS (advanced driving system) can perform all parts of the driving task in some conditions, but the human driver is required to be able to regain control when requested to do so by the ADS. In the remaining conditions, the human driver executes the necessary tasks. At level 4, the vehicle's ADS can perform all driving tasks independently in certain conditions in which human attention is not required. Finally, level 5 involves full automation whereby the vehicle's ADS can perform all tasks in all conditions, and no driving assistance is required from the human driver. This full automation can be enabled by the application of high speed wireless communication (e.g., 5G) technology, which can allow vehicles to communicate not just with one another, but also with traffic lights, signage and even the roads themselves, among other things.

While significant advances have been made in autonomous vehicles in recent years, these vehicles can still be improved in many respects. For example, while an autonomous vehicle is being driven at level 0 (i.e., “manually”), the driver may not have experience driving in different encountered contexts (e.g., animals on the road, inclement weather, etc.) and might have difficulty safely navigating the vehicle. As discussed, level 0 (zero) refers to a vehicle that has no driving automation technology. In this case, the driver is entirely in charge of operating the vehicle's movement, including steering, accelerating, braking, parking, and any other necessary maneuver to move the car in any direction. In the above example, if the driver is not able to safely drive then the autonomous vehicle might take control of navigating the vehicle. Embodiments of the present invention provide a solution to predict what types of driving scenarios will be upcoming and proactively provide training to the driver to drive in such contextual situations.

The present invention enables the ability to deliver specific scenarios (or contexts) to an individual within her autonomous vehicle when and where required. These highly specific simulations can be for a specific predicted event that might occur within the user's predicted route, for that specific trip/day. Within this example, the user might be new to driving within the country in rural farmland and never dealt with potential farm animals on the road. Based on the predicted route for that day, the system identifies this “experience gap” within the user's experiences and has a highly specific simulation for the user to take for a few moments before departing, so the user gets experience with how any encountered farm animals might react to the vehicle and how to handle them within this context. While sitting in the vehicle, before the user leaves their location (e.g., driveway), the system runs a simulation to show the context and educate the driver. The driver can now understand what to expect in a farmland animal driving experience.

Safety in the most important factor pertaining to content delivery for the present invention. There are two approaches to content delivery within the produced simulations. The vehicle can be parked (stationary) and the content will be delivered without any real movement, which is an embodiment of this invention. Secondly, the content can be delivered to the user while the vehicle is moving, but the user must opt-in to the dynamic movement module for mobile content delivery. Further, the system seeks to ensure that the vehicle can check and validate that the content will not cause any harm to the user/driver, passengers, vehicle, road, pedestrians, or other vehicles. The vehicle can validate this is safe time prior to any simulation through validating an array of sensors for omnipresent viewpoints that face 360 degrees around the vehicle. Mobile delivery should only be considered by the user for the content if it can be delivered safely and effectively while keeping all people and vehicles safe.

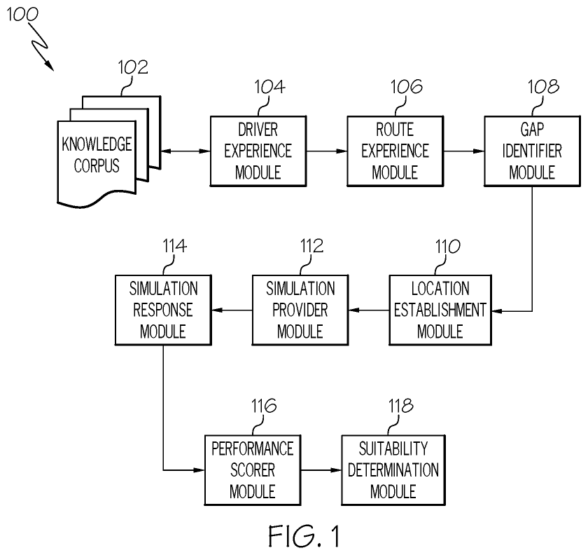

Referring to the drawings, FIG. 1 depicts a block diagram of a proactive driving training simulation system 100 (hereinafter referred to as “system 100”) for providing in-vehicle predicted context-based proactive driving training using an autonomous vehicle, in accordance with embodiments of the present invention. The system architecture includes knowledge corpus 102, driver experience module 104, route experience 106, driver experience gap identifier module 108, location establishment module 110, simulation provider module 112, simulation response module 114, performance scorer module 116, and suitability determination module 118.

Driver experience module 104 is configured to maintain a historical knowledge corpus 102 of a driver's driving experience. The knowledge corpus 102 includes the driving experiences of a given driver across various contextual scenarios (e.g., weather, road conditions, steering and speed control, etc.). The knowledge corpus 102 further includes a driver's response to each contextual scenario of each collective driving experience. Knowledge corpus 102 can store historical and real-time driving data.

Route experience module 106 is configured to identify a type of driving context (or scenario) that is expected based on a forthcoming route and generate an experience score based on the driver's previous experience within the identified context. In an example, the forthcoming route can be predicted based on historical driving information retrieved from knowledge corpus 102. In another example, the forthcoming route can be ascertained from retrieved driving directions based on a user's manual entry of a driving destination. To predict a driving context, route experience module 106 captures weather information, geographic and location specific information; historical data from knowledge corpus 102; and the like. For example, assume a new driver has started driving herself to school and back to her home using the same route. Each day, she has driven in dry conditions. She departs one morning for her school, and it begins to rain. She has not experienced driving in these conditions. Route experience module 106 uses knowledge corpus 102 and the current driving conditions (e.g., rain, snow, wind, fog, day/night, road type, traffic, etc.) to generate a scoring for the level of experience the driver has for the forthcoming predicted driving scenario. In this example, route experience module 106 generates a low driving experience score (e.g., 2 out of 10) for the new driver because she doesn't have experience in wet conditions along the route, but she has driven the route many times.

Driver experience gap identifier module 108 is configured to identify, based on the generated driving experience score, an experience gap in a driver's driving. Based on the score generated by route experience module 106, driver experience gap identifier module 108 determines whether the score represents an experience gap in the level of experience between the driver and the anticipated forthcoming driving conditions that necessitates driver simulation training for the driver. For example, an “experience gap” might be identified if the generated experience score for the context is 5 or less on a scale of 1-10. Referring to the preceding example, based on the generated score, the driver has only driven in dry conditions along that route. She is now faced with driving the route in wet conditions. Driver experience gap identifier module 108 identifies that she doesn't have the experience in such context, and likewise for other types of contextual scenarios. Based on the identified experience gap, a driving training simulation can be generated for the driver, as discussed below. The proposed system 100 collates various data points related to a predicted driving context (e.g., road condition, accidental scenario, traffic etc.), vehicle health, driver's skills, behavior of surrounding vehicles, weather condition etc. and, based on all factors, provides training to the driver so that the driver will be able to navigate the upcoming driving context safely.

Location establishment module 110 is configured to establish a location to initiate/activate the training requirement in mixed reality. Location establishment module 110 identifies current driving conditions that are amenable to running a mixed reality simulation. The simulation is performed inside the vehicle. System 100 adds on to the software in an autonomous vehicle. It will leverage the computing power from the autonomous vehicle to perform simulation of forthcoming driving situations. The vehicle will leverage sensors all around the car that collect data from its surroundings and also detect any upcoming situations within a predefined distance. The vehicle will also retrieve additional data, such as data on location, road conditions, weather, etc.

It can consider such conditions as traffic density of road/highway/intersection, available roadway space to perform required maneuvers, presence of other vehicles along the route, presence of pedestrians/cyclists in the road, availability of physical safe barriers to prevent collision with hazards, weather conditions, and the like. The above list is exemplary only and not intended to be limiting.

As stated, there are two approaches to content delivery within the produced simulations. The vehicle can be parked (stationary) and the content will be delivered by the vehicle to the driver/user without any real movement, which is an embodiment of this invention. Secondly, the content can be delivered by the vehicle to the user while the vehicle is moving, but the user must opt-in to the dynamic movement module for mobile content delivery. Based on the identified experience gap in driving experience and current driving conditions, the location establishment module 110 can establish a list of one or more potential locations where training can be provided when the user has selected the second approach above.

Simulation provider module 112 is configured to provide proactive training to a driver using mixed reality simulation. As stated, location establishment module 110 establishes one or more locations that are amenable to running a training simulation. In determining an appropriate location when mobile content delivery is used, various factors are considered such as availability of available physical space to perform maneuvers, presence of other vehicles in the vicinity that might influence performance or safety of maneuvers, weather conditions that might adversely affect chances for success when a driving event is required, and the like. Simulation provider module 110 can provide information on the various potential training locations to a driver via informational displays in the vehicle.

Simulation provider module 110 can generate a mixed reality or virtual training simulation on a mixed reality device (e.g., virtual reality headset or vehicle windshield, vehicle windows, and/or mirrors). Mixed reality (MR) is a technology that blends virtual reality (VR) and augmented reality (AR). In a mixed reality example, the simulation functions as an overlay (holographic representations) on top of what is being perceived by the driver through the vehicle windshield, windows, and/or mirrors.

In an example, a driver (Martin) has a navigation route that will take him into Acme National Park where free-roaming animals are often obscuring the road. Martin has not driven in the park before (an experience gap in his driving experience). Prior to entering the park, on clear and wide stretches of road, simulation provider module 110 renders virtual animals crossing his path, training Martin to avoid these animals while evaluating his performance. If the training simulation is provided with the virtual animals superimposed on the driver windshield, Martin will use the steering wheel, gas and/or brake pedal to navigate the vehicle, attempting to maneuver around the virtual animals. As a user is being trained in a moving vehicle, the vehicle will drive itself in autonomous mode and “ignore” the steering wheel/brake inputs and just continue doing its maneuvering. The user will feel the near-to-real experience while being trained using haptic and other sensory feedback mechanisms. Alternatively, the vehicle can perform a modified version of the user action based on what is determined to be “safe” under the circumstances. Martin will be scored accordingly (performance score) based on his ability to do so, as discussed below. If the simulation is provided using a VR headset, the driver will be notified of a safe place to park the vehicle while he completes the training simulation.

In another example, Jeremy mainly drives on rural routes. Jeremy is driving into a suburban area for the first time and, as such, needs to be trained how to drive in this context (e.g., to avoid a child who unexpectedly darts into the street). Simulation provider module 110 renders an appropriate virtual scenario (on the windshield, windows, and rear-view mirrors) where Jeremy can practice dealing with this situation and learn how to brake properly to carefully navigate around these unpredictable obstacles should he encounter them while driving.

Simulation response module 114 is configured to evaluate how the driver is handling the driving scenario using the mixed reality device(s) during the training simulation. Once the driver is at the location selected as optimal for the training simulation, the training simulation is started. The mixed reality environment includes virtual objects which are superimposed on the vehicle windshield, the windows of the vehicle, the rear-view mirror, and the side mirrors. The mixed reality system uses sensors and cameras to track the vehicle as it moves along the route. Virtual objects such as traffic lights will appear, change color, and animate in correspondence with physical traffic signals that are observed by mixed reality tracking devices. On-road training simulation can be synchronized with additional information, such as hazard notifications from other vehicles on the road, weather, etc. In addition, a training coach or driving suggestion information (e.g., audio, display screen, windshield overlay) can be provided to the driver via appropriate media visible and/or audible to her in the vehicle. Appropriate safety measures are maintained for this type of training so that the driver may proceed as if she were driving normally and not engage in hazardous maneuvers likely to create a safety hazard. These safety measures may include simulation response module 114 continually monitoring the safety of the training simulation and when new contextual situations occur such as the presence of traffic, pedestrians or other hazards, system 100 may interrupt the training simulation to present appropriate information.

Performance scorer module 116 is configured to generate a score related to driver performance during a training simulation. After the training simulation is complete, performance scorer module 116 can go through data collected during the training simulation and identify points of the driving simulation that can be identified as sub-optimal or unsafe. Performance scorer module 116 can then generate a scorecard for the driver based on a level of performance during the training simulation. Based on the final scorecard generated for the driver, system 100 will determine appropriate recommendations for actions to be taken by the driver to improve her performance.

Suitability determination module 118 is configured to generate a determination of a driver's suitability to address a real-life scenario based on her driving performance during the training simulation. After completing the training session, suitability determination module 118 can consider all variables that indicate whether a driver is ready to face a particular real-life driving situation. Factors such as driving behavior during the training simulation and the driver's current level of experience can be considered. If suitability determination module 118 identifies the driver is not able to drive properly in the actual scenario which was predicted, then autonomous vehicle will be taking a higher degree of autonomous control. If suitability determination module 118 determines the driver is indeed able to drive safely in the actual scenario, then the driver can choose to resume manual driving or allow the car to drive autonomously. In an example, system 100 can proceed to provide more advanced simulations that give opportunities for the driver to face situations which might be too dangerous at present but can be faced in the future with increased experience and competence of the driver, resulting in training simulations that grow with the driver's experience.

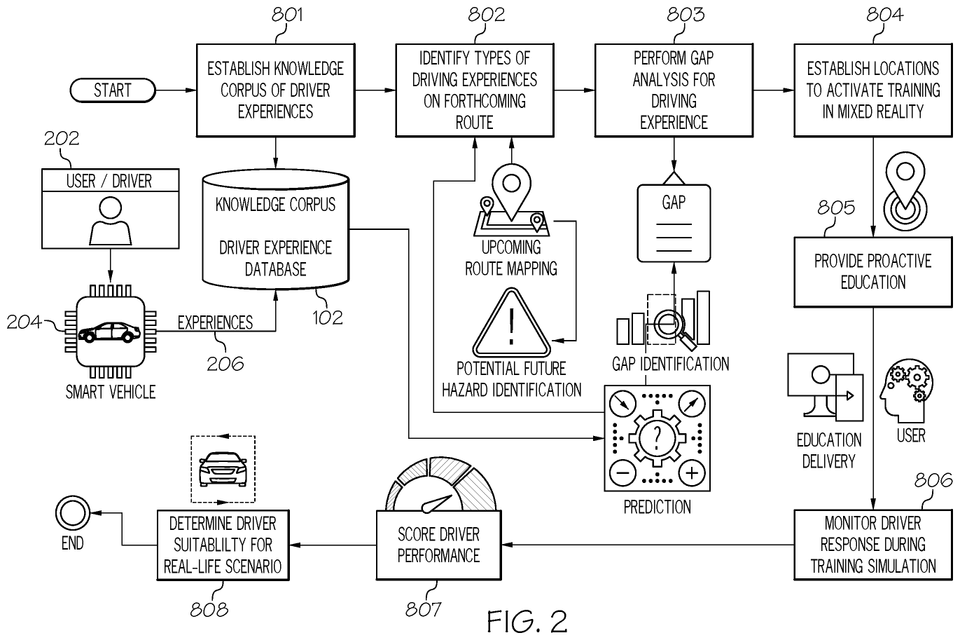

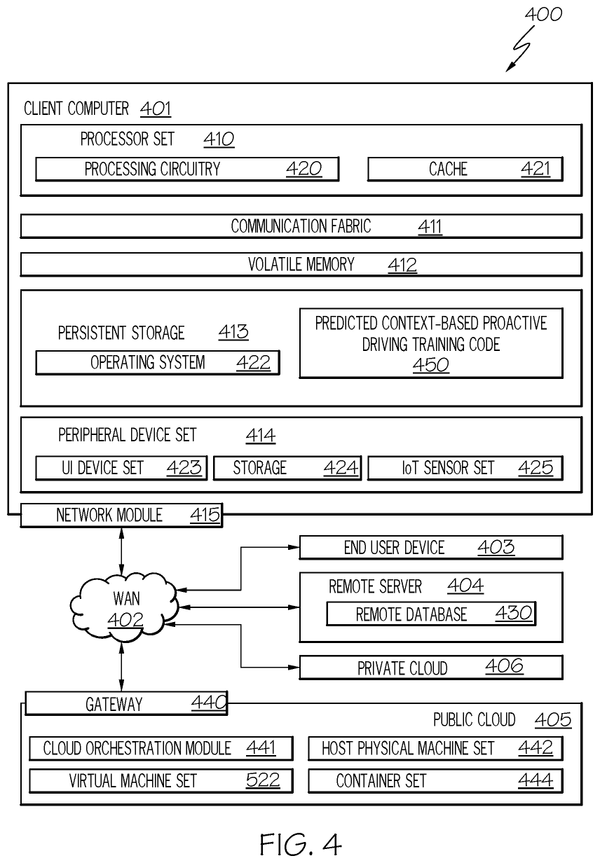

Referring now to FIG. 2, a flow chart 200 of a method for in-vehicle predicted context-based proactive driving training using an autonomous vehicle is depicted in accordance with embodiments of the present invention. One embodiment of a method 200 or algorithm that may be implemented for providing in-vehicle predicted context-based proactive driving training using an autonomous vehicle with the system 100 described in FIG. 1 using at least one computer system as defined generically in FIG. 4 below, and more specifically by the specific embodiments of FIG. 1.

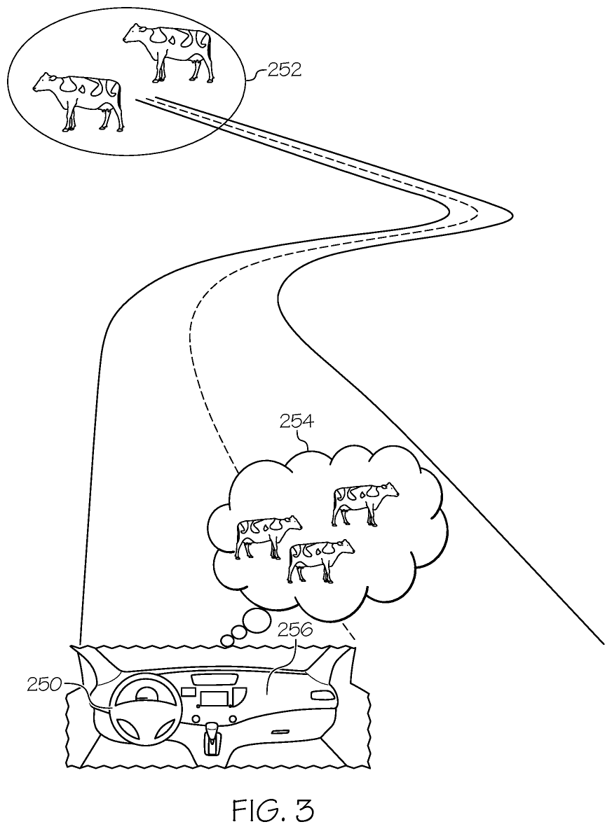

FIG. 3 depicts an example driving scenario in accordance with embodiments of the present invention. In the example, Joe is driving an autonomous vehicle in manual mode and system 100 predicts a new driving context/scenario is upcoming in which Joe is not experienced. Accordingly, system 100 proactively provides a driving training simulation so that Joe can learn to address the scenario so that when the actual scenario comes, Joe will be able to drive the vehicle safely. The components of FIG. 2 will be described in detail below with reference to FIG. 3.

Embodiments of the method 200 for providing in-vehicle predicted context-based proactive driving training using an autonomous vehicle, in accordance with embodiments of the present invention, may begin at step 801 wherein driver experience module 104 establishes knowledge corpus 102 (e.g., driver experiences database) which stores the driving experiences 206 of user/driver 202 (Joe, in this example) of smart/autonomous vehicle 204. Driver experience module 104 is configured to capture the driving experiences of a given driver across various contextual scenarios including weather, road conditions, and so forth.

At step 802, route experience module 106 is configured to identify the types of driving experience that Joe might experience on his forthcoming route. To that end, route experience module 106 identifies potential future hazards (e.g., obstacles, inclement weather, etc.) along the expected upcoming route. In the example of FIG. 3, Joe plans to drive through a rural farmland area and has never driven through such an area. There is a potential for in this area for cows 252 or other farm animals to be in the road as Joe travels through making it tricky for him to navigate his way.

At step 803, driver experience gap identifier module 108 is configured to perform an experience gap analysis between the driving experience of a user/driver 102 and a driving scenario that he might encounter on his forthcoming route. Driver experience gap analysis involves the examination and assessment of a driver's previous driving experience with a potential driving scenario for the purpose of determining whether the driver might be capable of handling the potential driving scenario properly and safely. If the driver has previous experience in the potential driving context, the driver will be able to continue operating smart vehicle 204 in manual mode. In the example, based on Joe's predicted route for the day, driver experience gap identifier module 108 identifies an “experience gap” within Joe's previous driving experiences and what he might experience in his upcoming route because he has no previous driving experience in a rural farmland area.

At step 804, location establishment module 110 is configured to establish one or more locations for provide one or more locations that are amendable to activating a training simulation for user 202. To that end, location establishment module 110 can consider multiple factors including, but not limited to, traffic density, available road space to perform any required maneuvers, presence of other vehicles on the road, presence of pedestrians or cyclists on the road, weather conditions, and/or the like. Based on the identified experience gap in driving experience and current driving conditions, location establishment module 110 can establish a list of potential locations where training can be provided. In the example, location establishment mode 110 has identified required road space 256 is available to provide the driving training simulation. Joe selects this location to receive the simulation. In another example, location establishment module 110 can make the selection for user 202 from among the available options. In an embodiment, possible locations can be evaluated based on the factors above, which may be weighted. Based on the evaluation, each location can be assigned a value and ranked in order to perform the selection.

At step 805, simulation provider module 112 is configured to provide an in-vehicle proactive mixed reality driving training simulation to user 202. In one embodiment, simulation provider module 112 is configured to superimpose virtual objects and events into the view of user 202 engaging in real-world driving in autonomous vehicle 204 to produce a mixed reality environment. The mixed reality environment can include virtual objects which are shown on the vehicle windshield, vehicle window(s), and/or vehicle mirror(s). The mixed reality system can use any number of sensors and cameras to track the vehicle as it moves along a route. Virtual objects such as traffic lights can appear, change color, and animate in correspondence with physical traffic signals that are observed by the mixed reality tracking devices. In addition, the on-road training simulation can be synchronized with additional information such as hazard notifications from other vehicles on the road, weather, etc. As shown in FIG. 3, a highly specific farm animal simulation with virtual objects (cows) 254 superimposed on the windshield 250 of the vehicle 204 to simulate what Joe might encounter as he drives through the farmland. The simulation provides Joe with experience as to how animals may react to the vehicle and how to navigate safely around them. Joe is provided an immersive learning experience designed to guide a driver through the critical driving skills of the scenario without the increased risk inherent in the actual real-real world context. Joe must show that he can safely control the vehicle around the (simulated) animals in order to be provided the opportunity to drive in a manual mode through the actual farmland. In another example, Joe might perform the simulation through a VR headset before he disembarks on his journey. Likewise, he must show that he is able to safely maneuver the vehicle through the virtual scenario before being allowed to drive in a manual mode through the real-world scenario.

At step 806, simulation response module 114 is configured to monitor how the driver is driving during the training simulation. For example, simulation response module 114 can monitor driver speed and steering control, stopping distance, position on the road, maneuvering around obstacles, and/or the like. In the example of FIG. 3, Joe attempts to safely maneuver around the cows as he navigates his way through the virtual farmland.

At step 807, performance scorer module 116 is configured to generate a driving performance score based on the driver performance during the training simulation. After the training simulation is complete, performance scorer module 116 analyzes the data collected during the training simulation and identifies any points of performance that can be labeled as sub-optimal or unsafe. Performance scorer module 116 generates a score (or scorecard) for driver 202 based on his level of performance during the training session. In the example of FIG. 3, if Joe can safely navigate through the training simulation, he will be assigned a high score (such as 9 out of 10). If Joe accidentally hits one of the virtual animals, he will likely be assigned a low score (such as 1 out of 10). Again, factors such as driver speed and steering control, stopping distance, position on the road, maneuvering around obstacles, and/or the like can be used when assigning a driving performance score.

At step 808, suitability determination module 118 is configured to, based on a driving performance score, determine driver suitability for a real-life driving scenario. After completing the training session, suitability determination module 118 considers all variables that indicate whether driver 202 is ready to face a forthcoming real-life driving situation. Factors such as driving behavior during the training simulation and the driver's current level of experience can be considered when making such a determination. If suitability determination module 118 identifies the driver is not able to drive properly in the actual scenario which was predicted, then autonomous vehicle can take an appropriate degree of autonomous control (i.e., shift out of manual driving mode). If driver 202 is determined able to drive properly in the actual scenario, then driver 202 can choose to resume manual driving or allow the car to drive autonomously.

FIG. 4 depicts a block diagram of a computer system for the driving training simulation system of FIG. 1, capable of implementing in-vehicle predicted context-based proactive driving training using an autonomous vehicle. Computing environment 400 contains an example of an environment for the execution of at least some of the computer code involved in performing the inventive methods, such as a new in-vehicle predicted context-based proactive driving training using an autonomous vehicle code block 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction paths that allow the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 101 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 101. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 101 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 406 are both part of a larger hybrid cloud.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for in-vehicle predicted context-based proactive driving training comprising:
predicting, by a processor of a computing system, a driving context of a forthcoming driving route;
performing, by the processor, an experience gap analysis between a driving experience of a driver and the predicted driving context to identify an experience gap;
providing, by the processor, in response to the experience gap being identified, an in-vehicle driving training simulation to the driver related to the predicted driving context;
evaluating, by the processor, a response of the driver to the in-vehicle driving training simulation to produce a driving performance score; and
determining, by the processor, based on the driving performance score, a suitability of the driver to safely navigate the predicted forthcoming driving route.

2. The method of claim 1, further comprising identifying, by the processor, a location to safely initiate the in-vehicle driving training simulation while the autonomous vehicle is in motion.

3. The method of claim 2, further comprising allowing, by the processor, the driver to continue driving in a manual mode when the driver is determined suitable to safely navigate the predicted forthcoming driving route.

4. The method of claim 2, further comprising transferring control, by the processor, of the autonomous vehicle from a manual mode to the vehicle when the driver is not determined suitable to safely navigate the forthcoming driving route.

5. The method of claim 1, wherein the in-vehicle driving training simulation includes generating a mixed reality representation of the predicted driving context.

6. The method of claim 5, further comprising superimposing, by the processor, any number of virtual objects onto a windshield of the autonomous vehicle.

7. The method of claim 1, further comprising maintaining, by the processor, a knowledge corpus of driving experiences of the driver to store current route information for use in performing a subsequent experience gap analysis.

8. A computing system for an autonomous vehicle, comprising:
a processor;
a memory device coupled to the processor; and
a computer readable storage device coupled to the processor, wherein the storage device contains program code executable by the processor via the memory device to implement a method for predicted context-based proactive driving training for a driver of the autonomous vehicle when in a manual driving mode, the method comprising:
predicting, by the processor, a driving context of a forthcoming driving route;
performing, by the processor, an experience gap analysis between a driving experience of a driver and the predicted driving context to identify an experience gap;
providing, by the processor, in response to the experience gap being identified, an in-vehicle driving training simulation to the driver related to the predicted driving context;
evaluating, by the processor, a response of the driver to the in-vehicle driving training simulation to produce a driving performance score; and
determining, by the processor, based on the driving performance score, a suitability of the driver to safely navigate the predicted forthcoming driving route.

9. The computing system of claim 8, further comprising identifying, by the processor, a location to safely initiate the in-vehicle driving training simulation while the autonomous vehicle is in motion.

10. The computing system of claim 9, further comprising allowing, by the processor, the driver to continue driving in a manual mode when the driver is determined suitable to safely navigate the predicted forthcoming driving route.

11. The computing system of claim 9, further comprising transferring control, by the processor, of the autonomous vehicle from a manual mode to the vehicle when the driver is not determined suitable to safely navigate the forthcoming driving route.

12. The computing system of claim 8, further comprising a mixed reality generator to generate a mixed reality representation of the predicted driving context.

13. The computing system of claim 12, further comprising a mixed reality display enabled windshield and superimposing, by the processor, any number of virtual objects onto the windshield.

14. The computing system of claim 8, further comprising a knowledge corpus of the driver's driving experiences of the driver and maintaining, by the processor, the knowledge corpus to store current route information for use in performing a subsequent experience gap analysis.

15. A computer program product for in-vehicle predicted context-based proactive driving training, the computer program product comprising a computer readable storage device, and program instructions stored on the computer readable storage device, to:
predict a driving context of a forthcoming driving route;
perform an experience gap analysis between a driving experience of a driver and the predicted driving context to identify an experience gap;
provide in response to the experience gap being identified, an in-vehicle driving training simulation to the driver related to the predicted driving context;
evaluate a response of the driver to the in-vehicle driving training simulation to produce a driving performance score; and
determine, based on the driving performance score, a suitability of the driver to safely navigate the predicted forthcoming driving route.

16. The computer program product of claim 15, further comprising program instructions stored on the computer readable storage device to identify a location to safely initiate the in-vehicle driving training simulation while the autonomous vehicle is in motion.

17. The computer program product of claim 16, further comprising program instructions stored on the computer readable storage device to continue driving in a manual mode when the driver is determined suitable to safely navigate the predicted forthcoming driving route.

18. The computer program product of claim 16, further comprising program instructions stored on the computer readable storage device to transfer control of the autonomous vehicle from a manual mode to the vehicle when the driver is not determined suitable to safely navigate the forthcoming driving route.

19. The computer program product of claim 15, further comprising program instructions stored on the computer readable storage device to generate a mixed reality representation of the predicted driving context.

20. The computer program product of claim 19, further comprising program instructions stored on the computer readable storage device to superimpose any number of virtual objects onto a windshield of the autonomous vehicle.
